(19) United States
(12) Patent Application Publication
(10) Pub. No.: US 2008/0020356 A1
(43) Pub. Date: Jan. 24, 2008

(54) Braille overlay member for a cell phone

(76) Inventor: Miriam Saba, Brooklyn, NY (US)

Correspondence Address: Ezra Sutton, Esq.;Plaza 9, 900 Route 9, Woodbridge, NJ, 07095, US

(21) Appl. No.: 11/491,711

(22) Filed: Jul. 24, 2006

(51) Int. Cl. G09B 21/00

(52) U.S. Cl. 434/113

(57) ABSTRACT

A Braille overlay member for use with a wireless cell phone by a blind or visually-impaired user. The Braille overlay member has a Braille embossed section thereon. The Braille overlay member includes a back surface having an adhesive layer, the adhesive layer; the adhesive layer has a peelable cover sheet attached thereto. The adhesive layer allows the Braille overlay member to be adhered to the keypad of the cell phone. The Braille-embossed section includes a plurality of number keys in Braille code representing the conventional number keys on a conventional cell phone keypad of a cell phone. The Braille-embossed section includes a plurality of special function keys in Braille code representing the conventional special function keys on the conventional cell phone keypad of the cell phone. Each of the number keys and the special function keys include one or more embossed and raised dots representing the numbers and letters in the Braille code for indicating a particular number or letter in Braille for use by the blind or visually-impaired user when making a telephone call using the wireless cell phone.

### FIELD OF THE INVENTION

This invention relates to a Braille overlay member for a cell phone for blind and visually-impaired individuals. More particularly, the Braille overlay member has an adhesive layer for adhesively attaching onto the cell phone keypad of a conventional cell phone and a Braille-embossed section having the numbers and the important “key” features in Braille numbers and letters.

### BACKGROUND OF THE INVENTION

Presently, there are hundreds of millions of blind and visually-impaired individuals living in the world. Most conventional landline phones and mobile phones include telephone designs having the phone keypad with standard visual forms of symbols on each individual number key (a number and/or letters) to assist the user in dialing a telephone number. It is important that these blind and visually-impaired persons have the same and equal opportunities for accessing the same facilities and services as the rest of the world's population. Wireless mobile phones and landline telephones need keypads having, Braille thereon in order to provide these blind and visually-impaired persons with a convenient way for accessing wireless communication services, such that a Braille keypad would help blind individuals in speaking with their friends and family; in placing service orders and buying products and services; as well as getting help in emergency situations. There are some Braille-aware wireless and landline phone keypads that use and provide embossed and/or raised dots arranged on each number key and special function keys. Such Braille keypads are costly and not readily or commercially available as standard items for most phones. Also, cell phone faceplates are well-known in the art to change the codes or design of an individual standard cell phone, but these faceplates do not change the appearance of the standard cell phone keypad.

There remains a need for a Braille overlay member for standard cell phones in order to provide blind and visually-impaired individuals with a convenient way for accessing wireless communications. Further, the Braille overlay member would include a Braille-embossed section having this embossed keypad section with raised dots that are arranged on each number key and special function keys for the convenience of the blind user. Additionally, the Braille overlay member would also include an adhesive layer for adhesively attaching the overlay to the conventional cell phone keypad for day-to-day use. The Braille overlay member would be detachably releasable from the standard cell phone keypad as desired by the user.

### DESCRIPTION OF THE PRIOR ART

Keypads having Braille indicia thereon and faceplates for cell phones are well-known in the prior art. These keypads having various designs, configurations, structures and materials of construction have been disclosed in the prior art. For example, U.S. Pat. No. 6,941,125 to MONTAGUE discloses a telephone having a keypad with ten number keys arranged to dial the digits from 0 to 9 inclusive. Each of these number keys is marked with a visual indicator denoting the digit which the number key is arranged to dial. The 1 and 9 number keys are provided with tactile indicators, distinguishable from one another by touch, so that a user can dial 911 by touch under conditions, such as in thick smoke or during a power failure, when the visual indicators on the keys are not readily distinguishable. The tactile indicators do not substantially obscure the visual indicators on the keys bearing the tactile indicators, and are not the Braille equivalents of these visual indicators. An existing telephone may be retrofitted with the tactile indicators by providing two auxiliary members which can be secured to the 1 and 9 number keys, preferably with adhesive. Additional tactile indicators distinguishable by touch may be provided on other keys needed to dial 911 on cordless or cellular telephones, such as the “on” and “send” keys on such telephones. This prior art patent does not disclose or teach the design, configuration and structure of a Braille overlay member for use with a wireless cell phone of the present invention.

U.S. Pat. No. 6,675,028 to HEIE, discloses an apparatus and an associated method for facilitating use of a mobile station by a visually-impaired user. A data message, such as an SMS (Short Message Service) message is provided to the mobile station during operation of the radio communication system in which the mobile station is operable, and is converted into Braille patterns readable by a visually-impaired user of the mobile station. This prior art patent does not disclose or teach the design, configuration and structure of a Braille overlay member for use with a wireless cell phone of the present invention.

German Patent Application No. DE2991923U1 to HESS discloses a mobile phone with Braille marked keys, an audio control signal, and an SMS message output. This prior art patent does not disclose or teach the design, configuration and structure of a Braille overlay member for use with a wireless cell phone of the present invention.

None of the prior art patents teach or disclose a Braille overlay member having a Braille-embossed section for use in conjunction with the telephone keypad section of a conventional cell phone, including embossed and raised dots that are arranged on each number key and on each of the special function keys as claimed in the present invention for the convenient use of visually-impaired or blind users.

Accordingly, it is an object of the present invention to provide a Braille overlay member for a cell phone that includes a Braille-embossed section with embossed and raised dots that are aligned to cover each number key and each of the special function keys in order to provide a convenient way for accessing wireless communication services by the blind and visually-impaired users.

Another object of the present invention is to provide a Braille overlay member for a cell phone having an adhesive layer for adhesively attaching onto the cell phone keypad for day-to-day use by the blind and visually-impaired users, such that the Braille overlay member is detachably releasable from the standard cell phone keypad as desired by the user. Another object of the present invention is to provide a Braille overlay member for a cell phone that is made of light-weight molded and flexible plastic, or is made from light-weight stamped metal, such as aluminum.

Another object of the present invention is to provide a Braille overlay member for a cell phone that is easy to use; and is durable and is easily cleanable for repeated use by the user.

A further object of the present invention is to provide a Braille overlay member for a cell phone that can be mass-produced in an automated and economical manner and is readily affordable by the user.

### SUMMARY OF THE INVENTION

In accordance with the present invention, there is provided a Braille overlay member for use with a wireless cell phone by a blind or visually-impaired user. The Braille overlay member has a Braille embossed section thereon. The Braille overlay member includes a back surface having an adhesive layer; the adhesive layer has a peelable cover sheet attached thereto. The adhesive layer allows the Braille overlay member to be adhered to the keypad of the cell phone. The Braille embossed section includes a plurality of number keys in Braille code representing the conventional number keys on a conventional cell phone keypad of a cell phone. The Braille embossed section also includes a plurality of special function keys in Braille code representing the conventional special function keys on the conventional cell phone keypad of the cell phone. Each of the number keys and the special function keys include one or more embossed and raised dots representing the numbers and letters in the Braille code for indicating a particular number or letter in Braille for use by the blind or visually-impaired user when making a telephone call using the wireless cell phone.

In an alternate embodiment, there is provided a Braille overlay card for use with a wireless cell phone by a blind or visually-impaired user. The Braille overlay card has a Braille-embossed section thereon. The Braille overlay card includes a back surface having an adhesive layer; the adhesive layer has a peelable cover sheet attached thereto. The Braille embossed section includes a plurality of individually perforated number keys in Braille code representing the conventional number keys on a conventional cell phone keypad of a cell phone; each of the individually perforated special function keys are positioned and adhesively placed on the conventional special function keys on the conventional cell phone keypad of the cell phone. Each of the perforated number keys and the perforated special function keys include one or more embossed and raised dots representing the numbers and letters in the Braille code for indicating a particular number or letter in Braille for use by the blind or visually-impaired user when making a telephone call using the wireless cell phone.

### BRIEF DESCRIPTION OF THE DRAWINGS

Further objects, features and advantages of the present invention will become apparent upon the consideration of the following detailed description of the presently preferred embodiment when taken in conjunction with the accompanying drawings, wherein

FIG. 1A is a front perspective view of the Braille overlay member for a cell phone of the preferred embodiment of the present invention showing the Braille overlay member having a Braille-embossed section, an adhesive layer and peelable cover sheet;

FIG. 1B is an enlarged perspective view of the Braille overlay member for a cell phone of the preferred embodiment of the present invention showing the Braille overlay member having a Braille-embossed section of a different design, an adhesive layer and a peelable cover sheet;

FIG. 2 is an exploded perspective view of the Braille overlay member for a cell phone of the present invention showing the Braille overlay member being adhesively placed on a wireless cell phone;

FIG. 3 is an enlarged partial perspective view of the Braille overlay member for a cell phone of the present invention showing one of the special function keys having a pair of embossed and raised dots on the individual key;

FIG. 4 is a cross-sectional view of the Braille overlay member for a cell phone of the present invention taken along lines 4-4 of FIG. 3 in the direction of the arrows showing the pair of embossed and raised dots on the individual key;

FIG. 5 is an exploded front perspective view of the Braille overlay member for a cell phone of an alternate embodiment of the present invention showing a plurality of precut and perforated Braille number and special function key pads being placed on the conventional cell phone keypad;

FIG. 6 is an enlarged perspective view of the Braille overlay member for a cell phone of the alternate embodiment of the present invention showing one of the individual key pads having an adhesive surface for attaching to one of the conventional keys on the cell phone keypad; and

FIG. 7 is a cross-sectional view of the Braille overlay member for a cell phone of the present invention taken along lines 7-7 of FIG. 6 in the direction of the arrows showing the pair of embossed and raised dots on the individual and perforated special function key.

### DETAILED DESCRIPTION OF THE PREFERRED AND ALTERNATE EMBODIMENTS

### Preferred Embodiment 10

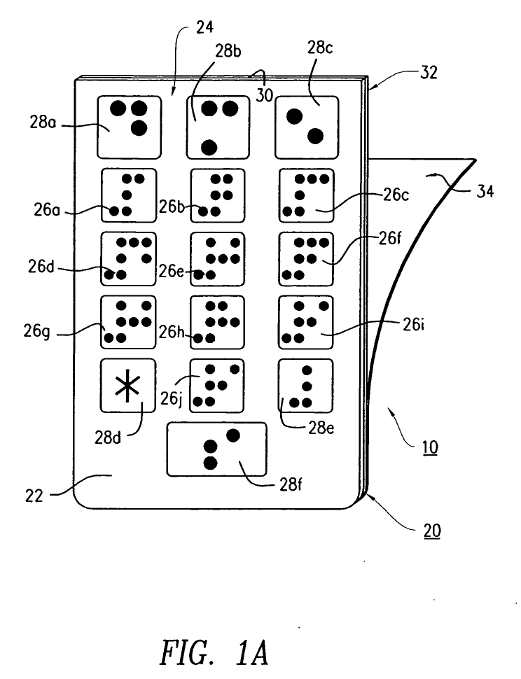

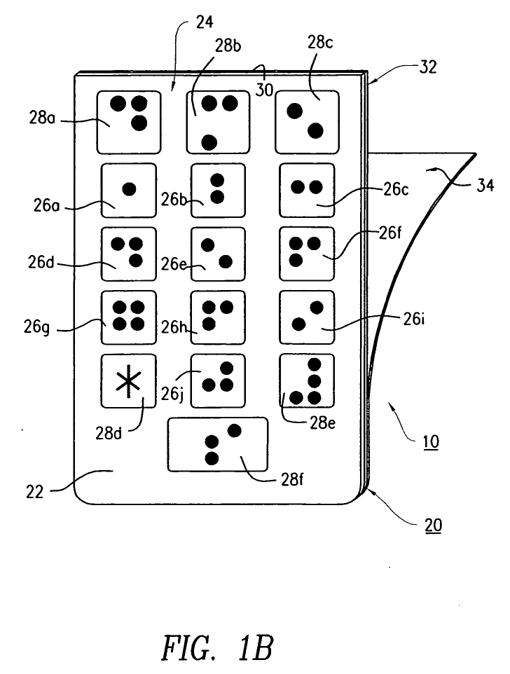

The Braille overlay member 10 and its component parts of the preferred embodiment of the present invention is represented in detail by FIGS. 1A, 1B and 2 through 4 of the patent drawings. The Braille overlay member 10 is used in conjunction with a conventional cell phone 12, such that the Braille overlay member 10 is adhesively placed and aligned on a standard cell phone keypad 14 having a plurality of number keys 16 and a plurality of special function keys 18 in order to provide a convenient means for accessing wireless communication services by blind and visually-impaired users.

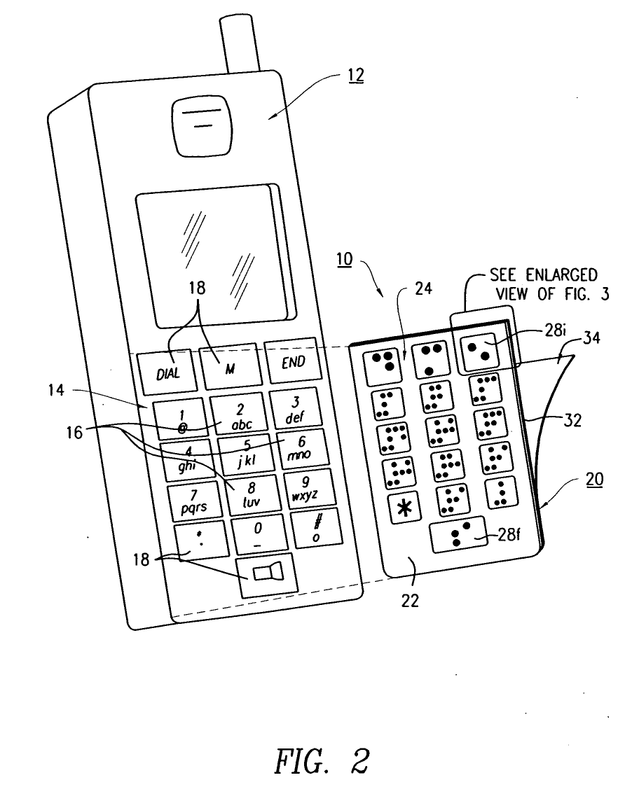

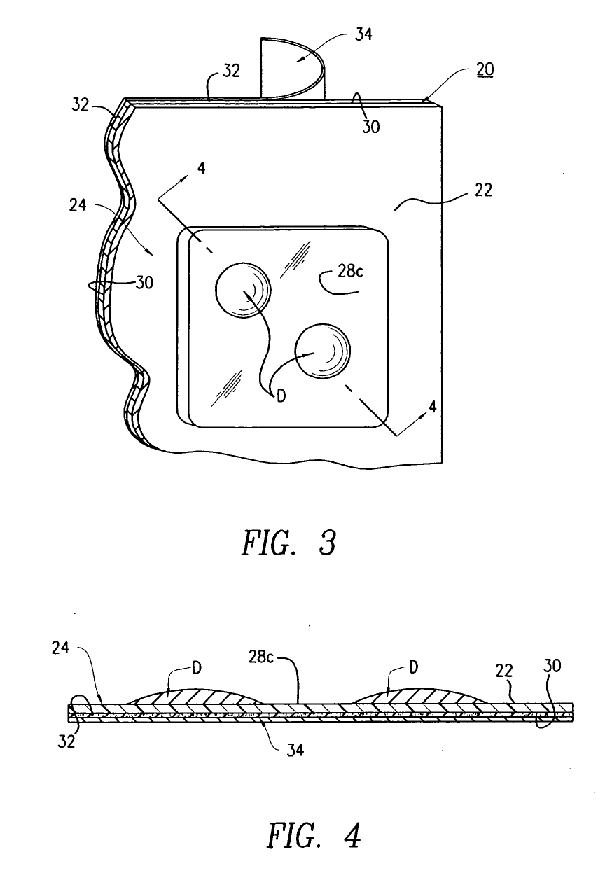

The Braille overlay member 10, as shown in FIGS. 1 and 2 of the drawings, includes a card member 20 being substantially rectangular in shape. The card member 20 includes a front surface 22 having a Braille-embossed section 24 thereon. The Braille-embossed section 24 includes a plurality of number keys 26a, 26b, 26c, 26d, 26e, 26f, 26g, 26h, 261 and 26j thereon representing the numbers “1”, “2”, “3”, “4”, “5”, “6”, “7”, “8”, “9” and “0” of the number keys 16, respectively, on the conventional cell phone keypad 14 of cell phone 12. The Braille-embossed section 24 also includes a plurality of special function keys 28a, 28b, 28c, 28d, 28e and 28f representing the special function keys 18 being the “dial function key”, the “message function key”, the “end call function key”, the “star function key”, the “pound function key” and the “speaker function key”, respectively, on the conventional cell phone keypad 14 of cell phone 12 (see FIG. 2). Each of the number keys 26a to 26j and the special function keys 28a to 28f include one or more embossed and raised dots D, representing the number and letters in the Braille code for indicating a particular number and/or letter in Braille for use by the blind or visually-impaired user when making a telephone call on the wireless cell phone 12 (see FIG. 3).

The card member 20 further includes a back surface 30 having an adhesive layer 32 thereon. The adhesive layer 32 has a peelable cover sheet 34 for protecting the adhesive layer 32 prior to use. The adhesive layer 32 is for adhesively attaching the Braille overlay member 10 to the keypad section 14 on the conventional cell phone 12, as shown in FIG. 2 of the drawings. The adhesive layer 32 can be in the form of double-sided adhesive tape, spray-on adhesive or contact adhesive and the like.

The Braille overlay member 10 can be made from embossed or moldable, flexible plastics, such as polyvinyl acetate, or be made from light-weight stamped metals such as aluminum. The Braille overlay member 10 can vary in size and shape depending upon the design and configuration of a particular brand/model of cell phone 12 used.

### Alternate Embodiment 100

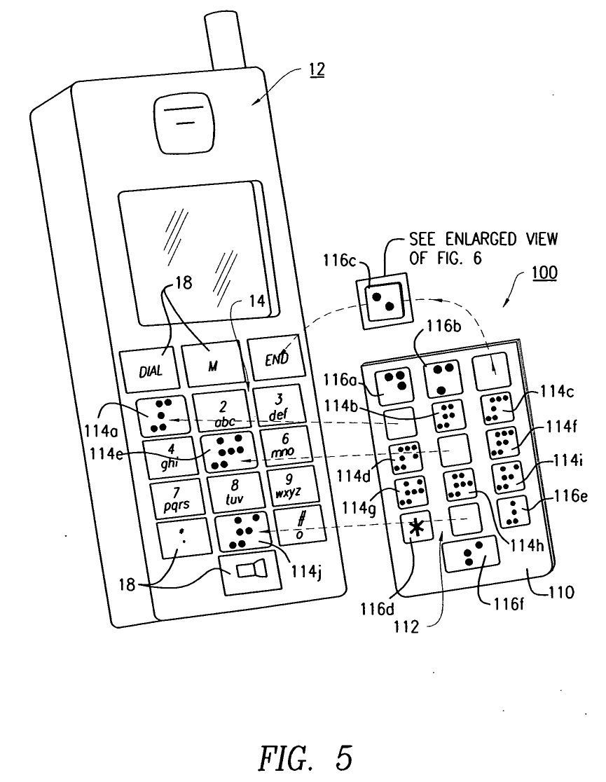

The Braille overlay card 100 and its component parts of the alternate embodiment of the present invention is represented in detail by FIGS. 5 to 7 of the patent drawings. The Braille overlay card 100 is used in conjunction with a conventional cell phone 12, such that individual Braille (cutout) number keys and special function keys are adhesively affixed on their respective cell phone number keys and special function keys of the conventional cell phone 12 in order to provide an inexpensive and convenient means for accessing wireless communication services by blind and visually-impaired users.

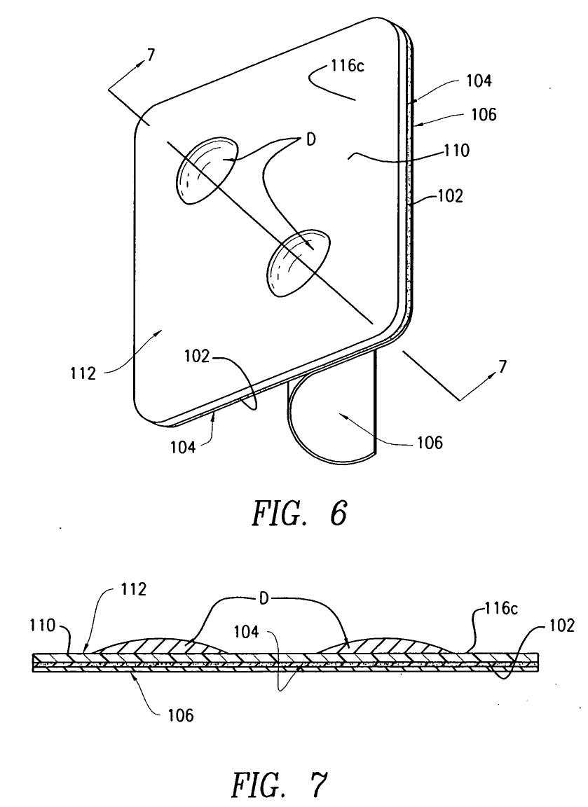

The Braille overlay card 100, as shown in FIG. 5, includes a substantially rectangular shaped card having a rear surface 102 having an adhesive layer 104 thereon. The adhesive layer 104 includes a peelable cover sheet 106 thereon to protect the adhesive layer 104 from dirt and debris. The Braille overlay card 100 includes a front surface 110 having a Braille-embossed section 112 thereon. The Braille-embossed section 112 includes a plurality of die-cut spaced-apart and punch-out (perforated) individual number keys 114a, 114b, 114c, 114d, 114e, 114f, 114g, 114h, 1141 and 114j thereon representing the numbers “1” to “9” and “0” of the number keys 16, respectively, on the conventional cell phone keypad 14 of cell phone 12. The Braille-embossed section 112 also includes a plurality of die-cut spaced-apart and punch-out (perforated) individual special function keys 116a, 116b, 116c, 116d, 116e and 116f representing the special function keys 18, respectively, on the conventional cell phone keypad 14 of cell phone 12. Each of the individual number keys 114a to 114j and the individual special function keys 116a to 116f include one or more embossed and raised dots D, representing the numbers and letters in the Braille code for indicating a particular number and/or letter in Braille for use by the blind or visually-impaired user when making a telephone call on the wireless cell phone 12 (see FIGS. 5 and 6).

### Operation of the Present Invention

As shown in FIGS. 1 and 2, the Braille overlay member 10 operates in the following manner. The user initially peels away the peelable cover sheet 34 from the adhesive layer 32 thereby exposing the adhesive layer 32 on the back surface 30 of the Braille overlay member 10. The user now aligns the Braille-embossed section 24 of front surface 22 with the number keys 16 and the special function keys 18 on the conventional cell phone keypad 14 of cell phone 12. The user then gently presses the Braille-embossed section 24 onto the conventional cell phone keypad 14, such that the plurality of number keys 26a to 26j and the plurality of special function keys 28a to 28f of Braille-embossed section 24 are adjacent and in contact with the number keys 16 (1 to 9) and the special function keys 18 of the cell phone keypad 14, accordingly. The conventional cell phone 12 has now been transformed into a Braille cell phone for accessing wireless communication services by blind and/or visually-impaired users.

In the alternate embodiment as shown in FIGS. 5 and 6, the Braille overlay card 100 operates in the following manner. The user initially peels away the peelable cover sheet 106 from the adhesive layer 104 thereby exposing the adhesive layer 104 on the rear surface 120 of the Braille overlay card 100. The user now individually removes (punches out) each of the individually perforated number keys 114a to 114j and also individually removes (punches out) each of the individually perforated special function keys 116a to 116f, such that the user then individually presses the appropriate number keys 114a to 114j and the appropriate special function keys 115a to 116f onto the corresponding number keys 16 and onto the corresponding special function keys 18 on cell phone keypad 14, accordingly. The conventional cell phone 12 has now been transformed into a Braille cell phone for accessing wireless communication services by blind and/or visually-impaired users.

### Advantages of the Present Invention

Accordingly, an advantage of the present invention is that it provides for a Braille overlay member for a cell phone that includes a Braille-embossed section with embossed and raised dots that are aligned to cover each number key and each of the special function keys in order to provide a convenient way for accessing wireless communication services by the blind and visually-impaired users.

Another advantage of the present invention is that it provides for a Braille overlay member for a cell phone having an adhesive layer for adhesively attaching onto the cell phone keypad for day-to-day use by the blind and visually-impaired users, such that the Braille overlay member is detachably releasable from the standard cell phone keypad as desired by the user.

Another advantage of the present invention is that it provides for a Braille overlay member for a cell phone that is made of light-weight molded and flexible plastic, or is made from light-weight stamped metals, such as aluminum.

Another advantage of the present invention is that it provides for a Braille overlay member for a cell phone that is easy to use; and is durable and is easily cleanable for repeated use by the user.

A further advantage of the present invention is that it provides for a Braille overlay member for a cell phone that can be mass-produced in an automated and economical manner and is readily affordable by the user.

A latitude of modification, change and substitution is intended in the foregoing disclosure, and in some instances, some features of the invention will be employed without a corresponding use of other features. Accordingly, it is appropriate that the appended claims be construed broadly and in a manner consistent with the spirit and scope of the invention herein.

What is claimed is:

1. A Braille overlay member for use with a wireless cell phone having a keypad by a blind or visually-impaired user, comprising:
a) a Braille overlay member having a Braille embossed section thereon;
b) said Braille overlay member including a back surface having an adhesive layer, said adhesive layer having a peelable cover sheet attached thereto, and said adhesive layer allows said Braille overlay member to be adhered to the keypad of the cell phone;
c) said Braille embossed section including a plurality of number keys in Braille code representing the conventional number keys on a conventional cell phone keypad of a cell phone;
d) said Braille embossed section including a plurality of special function keys in Braille code representing the conventional special function keys on the conventional cell phone keypad of the cell phone; and
e) each of said number keys and said special function keys include one or more embossed and raised dots representing the numbers and letters in the Braille code for indicating a particular number or letter in Braille for use by the blind or visually-impaired user when making a telephone call using the wireless cell phone.

2. A Braille overlay member in accordance with claim 1, wherein said Braille overlay member is made from a flexible plastic material such as polyvinyl acetate.

3. A Braille overlay member in accordance with claim 1, wherein said Braille overlay member is made from a flexible and light-weight metal material such as titanium or aluminum.

4. A Braille overlay member in accordance with claim 1, wherein said adhesive layer is selected from the group consisting of double-sided adhesive tape, spray-on adhesive and contact adhesive.

5. A Braille overlay card for use with a wireless cell phone having a keypad by a blind or visually-impaired user, comprising:
a) a Braille overlay card having a Braille embossed section thereon;
b) said Braille overlay card including a back surface having an adhesive layer, said adhesive layer having a peelable cover sheet attached thereto, and said adhesive layer allows sections of said Braille overlay member to be adhered to the keypad of the cell phone;
c) said Braille embossed section including a plurality of sections in the form of separately perforated number keys in Braille code representing the conventional number keys on a conventional cell phone keypad of a cell phone; each of said separately perforated number of keys are removed from said embossed section and each of said number of keys is positioned and adhesively placed on the conventional number keys on the conventional cell phone keypad of the cell phone;
d) said Braille embossed section including a plurality of sections in the form of separately perforated special function keys in Braille code representing the conventional special function keys on the conventional cell phone keypad of the cell phone; each of said individually perforated special function keys are removed from said embossed section and each of said special function keys is positioned and adhesively placed on the conventional special function keys on the conventional cell phone keypad of the cell phone; and
e) each of said perforated number keys and said perforated special function keys include one or more embossed and raised dots representing the numbers and letters in the Braille code for indicating a particular number or letter in Braille for use by the blind or visually-impaired user when making a telephone call using the wireless cell phone.

6. A Braille overlay member in accordance with claim 5, wherein said Braille overlay card is made from a flexible and light-weight metal material such as titanium or aluminum.

7. A Braille overlay member in accordance with claim 5, wherein said adhesive layer is selected from the group consisting of double-sided adhesive tape, spray-on adhesive- and contact adhesive.
